(19) United States
(12) Patent Application Publication
(10) Pub. No.: US 2003/0101848 A1
(43) Pub. Date: Jun. 5, 2003

(54) Limited-slip differential for motor vehicles

(75) Inventors: Akio Handa, Wako-shi (JP); Akio Senda, Wako-shi (JP); Satoru Noguchi, Inasa-gun (JP); Hideaki Ina, Inasa-gun (JP); Takayuki Shinmura, Inasa-gun (JP)

Correspondence Address: MERCHANT & GOULD PC, P.O. BOX 2903, MINNEAPOLIS, MN, 55402-0903, US

(73) Assignee: Honda Giken Kogyo Kabushiki Kaisha, Tokyo (JP)

(21) Appl. No.: 10/313,487

(22) Filed: Dec. 4, 2002

(30) Foreign Application Priority Data
Dec. 5, 2001 (JP) 2001-371915

(51) Int. Cl. F16H 48/12

(52) U.S. Cl. 74/650

(57) ABSTRACT

A limited-slip differential includes a differential case having a two-piece structure formed by a cup-shaped case body and an end cap attached to an open end of the cup-shaped case body. The limited-slip differential having such two-piece differential case has a small number of parts, is easy to assemble and can be manufactured efficiently at a low cost, as compared to a conventional limited-slip differential having a three-piece differential case.

### FIELD OF THE INVENTION

The present invention relates to a limited-slip differential incorporated in a final drive of a motor vehicle for limiting differential action between left and right driving wheels of the motor vehicle to ensure that some power is always applied to each of the driving wheels.

### BACKGROUND OF THE INVENTION

When a vehicle with two-wheel drive turns a corner, the driving wheels (driven road wheels) rotate at different speeds, since the inside wheel has to travel a much shorter distance than the outside one. To take up a difference in rotational speed at the driving wheels, a differential is provided, which delivers the same torque to each driving wheel while allowing the driving wheels to rotate at different speeds.

The differential can thus take up the rotational speed difference. However, if one wheel begins to slip and spin on, for example, a low-μ road surface, power transfer to the other wheel decreases, which will slow down and stop the wheel. This may also stops the vehicle or prevent it from moving. To deal with this problem, four-wheel drive vehicles, off-road or recreational vehicles are equipped with a limited-slip differential that limits differential action between both wheels to thereby secure power transfer to each wheel.

One example of such known limited-slip differentials is shown here in FIG. 8. As shown in this figure, the known limited-slip differential 100 includes a first end cap 101, a first output cam 104 disposed in the first end cap 101 with a spring washer 102 and a thrust washer 103 disposed therebetween, a second output cam 111 disposed in a second end cap 113 in opposite relation to the first output cam 104, a series of circumferentially arranged input blocks 107, 108 (two being shown) engaged between the first and second output cams 104 and 111, and a cylindrical case body 106 connected at opposite ends to the first and second end caps 104, 111 and accommodating within it the first and second output cams 104, 111 and the input blocks 107, 108. The fast end cap 101, the case body 106 and the second end cap 113 together form a differential case 114. In an assembled state of the limited-slip differential 100, the input blocks 107, 108 are rotatable about the axis of the differential case 114 in unison with the differential case 114, and the second output cam 111 is urged against an inside surface of the second end cap 118 by the force of the spring washer 102.

With this arrangement, power from an engine (not shown) is transmitted successively through the differential case 114, the input blocks 107, 108 and the first and second output cams 104, 111 to drive axles (not shown).

Since the differential case 114 is composed of three separate parts, i.e., the first end cap 101, the case body 106 and the second end cap 113, the number of parts of the known limited-slip differential is relatively large. For assembly, the case body 106 and the second end cap 113 are connected by screw fasteners and finally welded together. The two-stage assembling process of the differential case 114, which becomes necessary due to the three-piece structure of the differential case 114, is tedious and time-consuming. This also lowers the production efficiency of the limited-slip differential 100 and increases the manufacturing cost of the limited-slip differential 100.

### SUMMARY OF THE INVENTION

It is, accordingly an object of the present invention to provide a limited-slip differential for motor vehicles, which has a relatively small number of parts, is easy to assemble and can be manufactured efficiently at a relatively low cost.

According to the present invention, there is provided a limited-slip differential incorporated in a final drive of a motor vehicle for limiting differential action between left and right driving wheels to thereby secure power transfer to each of the driving wheels, the limited-slip differential comprising a differential case having two-piece structure formed by a cup-shaped case body and an end cap attached to an open end of the cup-shaped case body.

Since the differential case has a two-piece structure, the limited-slip differential has a relatively small number of parts as compared to the conventional limited-slip differential having a differential case of three-piece structure. The two-piece differential case can be assembled easily in a relatively short time as compared to the conventional three-piece differential case which requires two-stage assembling process including welding. By virtue of the two-piece differential case, the limited-slip differential can be manufactured efficiently at a relatively low cost.

The limited-slip differential may farther include a ring gear formed integrally with the end cap. Integral formation of the ring gear and the end cap achieves a further reduction of the production cost

### BRIEF DESCRIPTION OF THE DRAWINGS

A preferred embodiment of the present invention will hereinafter be described in detail, by way of example only, with reference to the accompanying drawings, in which:

FIG. 1 is a perspective view of a motor vehicle in which a limited-slip differential according to the present invention is incorporated;

FIG. 2 is a perspective view of a power transmission mechanism of the motor vehicle;

FIG. 3 is an exploded perspective view of a front final drive of the power transmission mechanism including the limited-slip differential;

FIG. 4 is an exploded perspective view of the limited-slip differential incorporated in the front final drive;

FIG. 5 is a cross-sectional view taken along line 5-5 of FIG. 2, showing the front final drive and the limited-slip differential incorporated therein;

FIG. 6 is an exploded cross-sectional view of the limited-slip differential according to the present invention;

FIG. 7 is a cross-sectional view showing an end cap of a differential case formed integrally with a ring gear according to a modification of the present invention; and

FIG. 8 is a view similar to FIG. 6, but showing the structure of a conventional limited-slip differential.

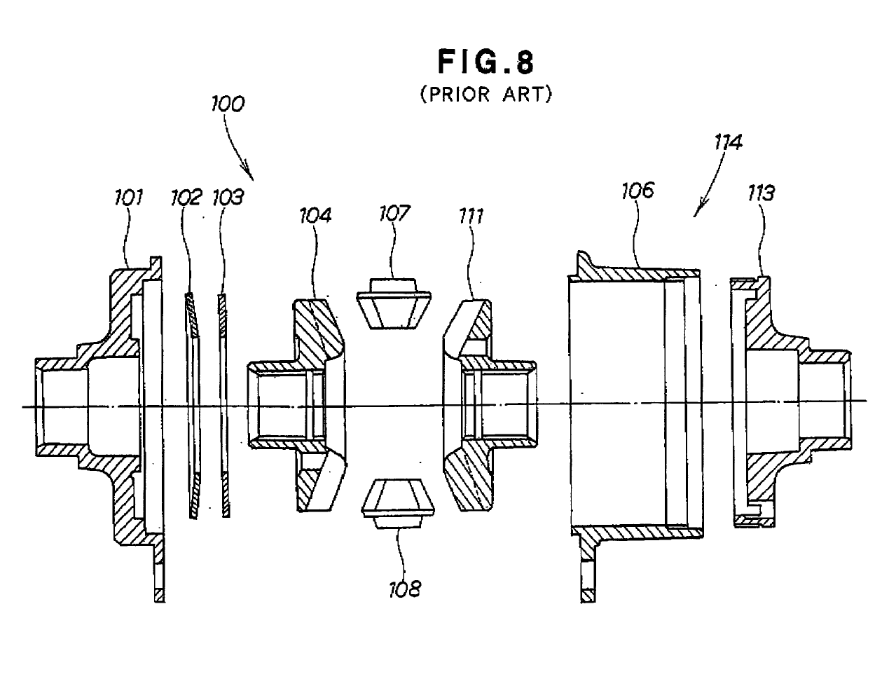

### DETAILED DESCRIPTION OF THE PREFERRED EMBODIMENT

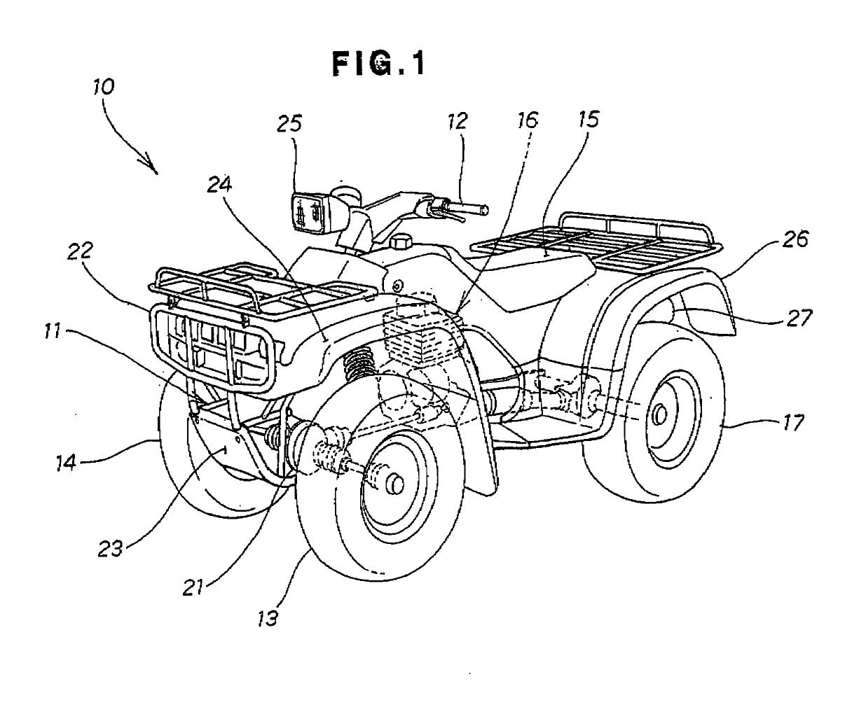

Referring now to the drawings and FIG. 1 in particular, there is shown a motor vehicle 10 in which a limited-slip differential according to the present invention is incorporated. As shown in this figure, the motor vehicle 10 includes a body frame 11, a steering handle 12 pivotally mounted on the body frame 11, left and right steerable front wheels 13 and 14 operatively connected via a steering device (not shown) to the steering handle 12 and connected via arms (not shown) to the body frame 11 for vertical movement a seat 15 mounted on an upper part of the body frame 11, a power unit 16 composed of an engine and a transmission disposed below the seat 15, and left and right rear wheels 17 (only the left one being shown). The front wheels 13, 14 and the rear wheels 17 can be simultaneously driven via a power transmission mechanism (described later) by the power unit 16.

The motor vehicle 10 also includes a front final drive 21 that forms a part of the power transmission mechanism. The front final drive 21 is disposed between the left front wheel 13 and the right front wheel 14 and contains within it the limited-slip differential according to the present invention. In FIG. 1, reference numeral 22 denotes a front bumper, 23 denotes an under cover, 24 denotes a front fender, 25 denotes a head lamp, 26 denotes a rear fender, and 27 denotes a muffler or silencer.

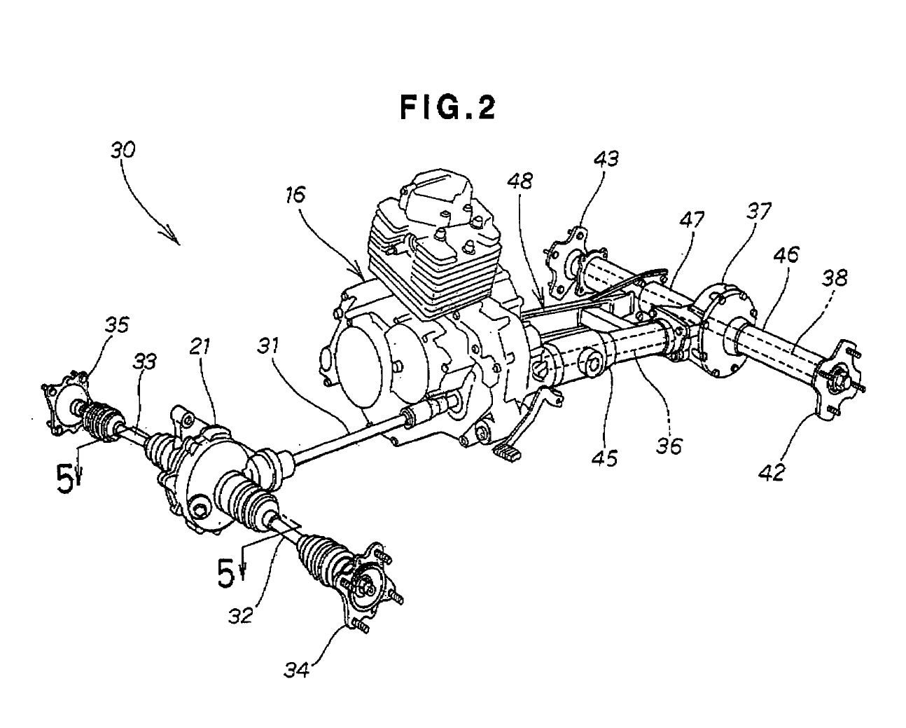

As shown in FIG. 2, toe power transmission mechanism 30 generally comprises a front propeller shaft 31 extending forwardly from a lower part of the power unit 16, the front final drive 21 connected to a front end of the front propeller shaft 31, front drive axles or shafts 32 and 33 extending transversely from the front final drive assembly 21 in opposite directions, left and right hubs 34 and 35 connected to the respective fore-ends of the front drive shafts 32, 33, a rear propeller shaft 36 extending rearward from a lower part of the power unit 16, a rear final drive 37 connected to a rear end of the propeller shaft 36, a rear drive axle or shaft 38 extending transversely through the rear final drive 37, and left and fight hubs 42 and 43 connected to opposite ends of the rear drive shaft 38. In FIG. 2, reference numeral 45 denotes a tube covering the rear propeller shaft 38, numerals 46 and 47 denote tubes covering left and right halves of the rear drive shaft 38, and numeral 48 denotes a support member for supporting the tubes 45, 47. The hubs 34, 35, 42, 43 each form a central part of a corresponding one of the wheels 13, 14, 17, by which the wheel is attached to the drive shaft 32, 33 or 38.

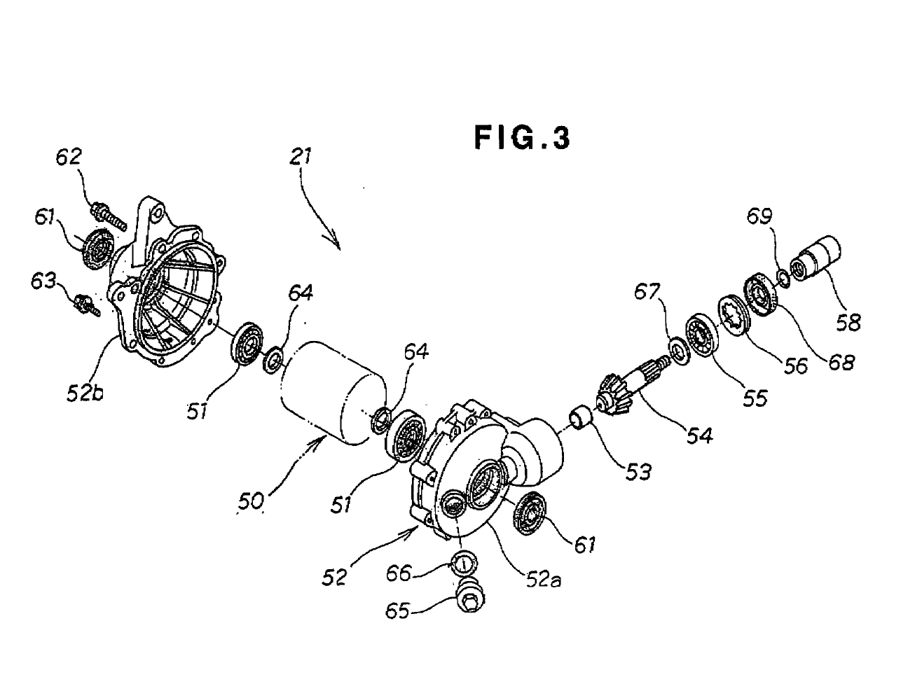

The front final drive 21, as shown in FIG. 3, includes a differential case assembly 50 forming the limited-slip differential of the present invention, a housing 52 rotatably accommodating within it the differential case assembly 50 via a pair of bearings 51, 51, a drive pinion 54 inserted via a bearing 53 in the housing 52 from the rear side of the housing 52, a bearing 55 rotatably mounting the drive pinion 54 to the housing 52, a lock nut 56 for locking the bearing 55 against removal from the drive pinion 54, and a joint 58 connected to a rear end of the drive pinion 54. In FIG. 3, reference character 52a denotes a housing body, 62b denotes a housing cover, 61 denotes an oil seal, 62 and 63 dote screws, 64 denotes a spacer, 65 denotes a plug normally dosing a maintenance hole (not designated), 66 denotes an O-ring, 67 denotes a spacer, 68 denotes an oil seal, and 69 denotes an O-ring.

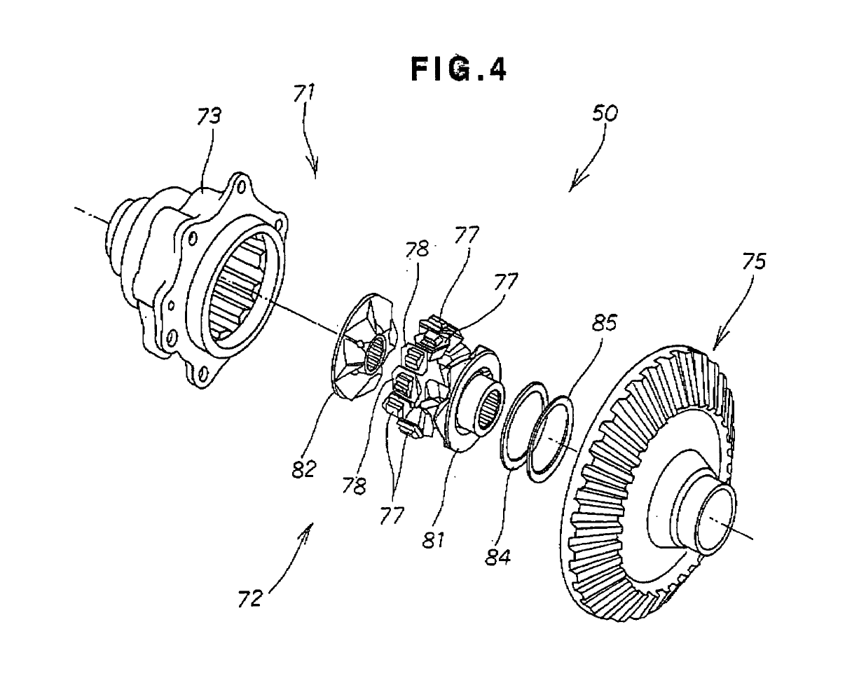

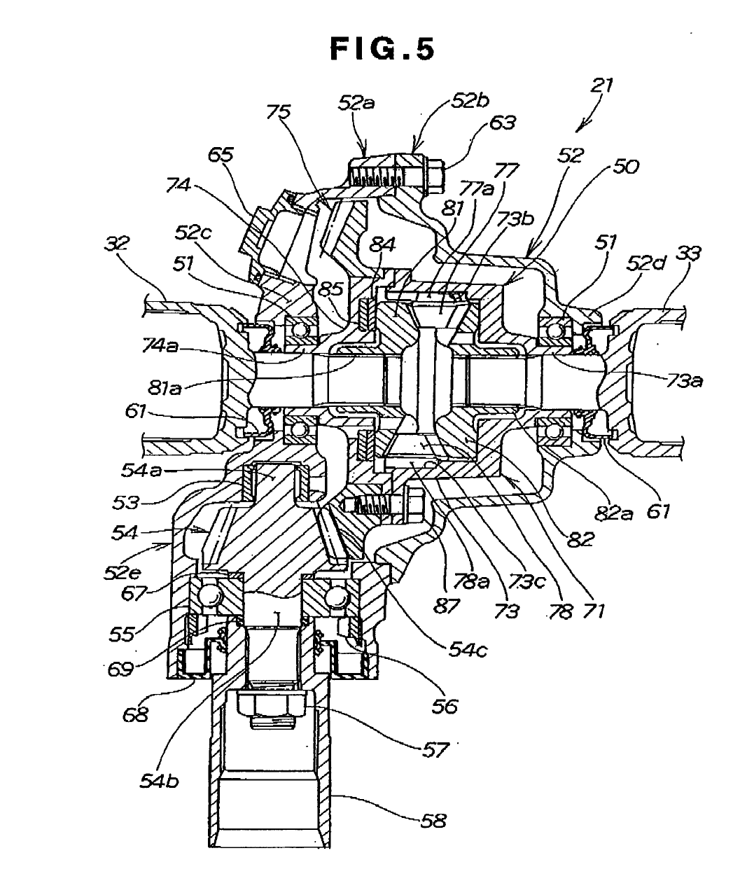

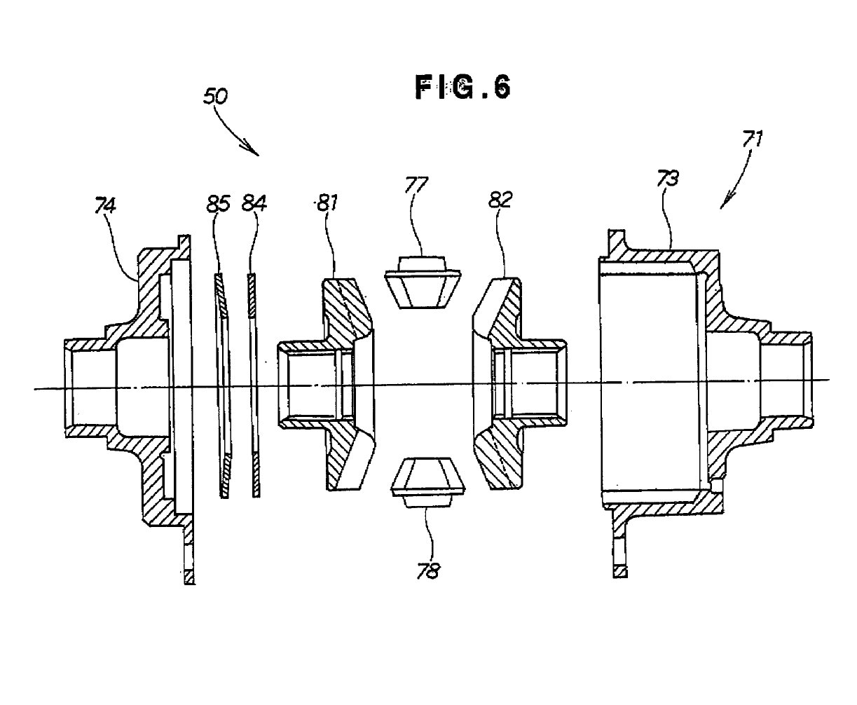

FIG. 4 is an exploded perspective view showing the structure of the differential case assembly 50 forming the limited-slip differential of the present invention. The differential case assembly 50 is comprised of a differential case 71 and internal parts 72 accommodated within the differential case 71. The differential case 71 has a two-piece structure formed by a generally cup-shaped case body 73 and an end cap 74 (FIGS. 5 and 6) attached to an open end of the cup-shaped case body 71. The differential case 71 also includes a ring gear 75 attached to the end cap 74.

The internal parts 72 of the differential case assembly 50 include two types of input blocks 77 and 78 arranged along the perimeter of a circle, left and right output cams 81 and 82 disposed in confrontation so as to grip the input blocks 77, 78 therebetween in such a manner that the input blocks 77, 78 are relatively slidable and the output cams 81, 82 are independently rotatable due to a frictional force acting between each output cam 81, 82 and the individual input blocks 77, 78, and two washers 84 and 85 both associated with the left output cam 81. The washer 84 is a thrust washer, and the washer 85 is a spring washer.

As shown in FIG. 5, the thrust washer 84 and the spring washer 85 are received in an annular groove (not designated) formed in an inside surface of the end cap 74 so that the left output cam 81 disposed in the end cap 74 is urged toward the right output cam 82 by the force of the spring washer 85. The right output cam 82 is disposed in the cup-shaped case body 73 in confronting relation to the left output cam 82, and the input blocks 77, 78 are arranged in a circumferential direction and held in contact with the left and right output cams 81, 82, The rig gear 75, the end cap 74 and the cup-shaped case body 73 are connected together by a plurality of screws 87 (only one being shown) such that the ring gear 75 is attached to the end cap 74. By virtue of the biasing force of the spring washer 85 acting thereon through the thrust washer 84, left output cam 81 and input blocks 77, 78, the right output cam 82 is urged against a inside surface of the cup-shaped case body 73.

The end cap 74 has a cylindrical boss 74a rotatably supported by the bearing 51 mounted on a bearing retaining portion 52c of the housing body 52. Similarly, the cup-shaped case body 73 has a cylindrical boss, 73a rotatably supported by the bearing 51 mounted on a bearing retaining portion 52d of the housing cover 52b. The housing body 52a and the housing cover 52b are connected together by a plurality of screws 63 (only one being shown) so as to form the housing 52. The differential case assembly 50 is rotatably mounted within the housing 52.

The housing body 52a has a rear cylindrical portion 52a extending at right angles to the front drive shafts 32, 33. The drive pinion 54 is rotatably received in the rear cylindrical portion 52a. The drive pinion 54a has a front journal part 54a rotatably supported by the bearing 53 mounted on a front end portion (upper end in FIG. 5) of the rear cylindrical portion 52a, and a rear journal part 54b rotatably supported by the bearing 53 mounted on an intermediate portion of the rear cylindrical portion 52a. The front and rear journal parts 54a, 54b are disposed on opposite sides of a pinion gear 54c of the drive pinion 54. The pinion gear 54c of the drive pinion 54 is in mesh with the ring gear 75. The lock nut 56 is threaded with an internally threaded portion (not designated) of the rear cylindrical portion 52a to lock the bearing 55 in position against removal from the drive pinion 54. The joint 58 is connected by a threaded fastener 57 to a rear end of the drive pinion 54. The oil seal 68 is fitted in an annular space defined between an inner peripheral surface of the rear cylindrical portion 52e and an outer peripheral surface of the joint 58.

Each input block 77 has a projection 77a fitted in one 73b of axial grooves formed in an inner cylindrical surface of the cup-shaped cue body 73 at circumferential interval. Similarly, each input block 78 has a projection 78a fitted in another one 73c of the axial grooves of the cup-shaped case body 73. With this arrangement, the input blocks 77, 78 are rotatable about the common axis of the front drive shafts 32, 33 in unison with the cup-shaped case body 73.

The left and right output cams 81, 82 each have a cylindrical boss 81a, 82a spline-connected to a corresponding one of the front drive shafts 32, 33 for transmission of a driving force to the left and right front wheels 13, 14 (FIG. 1). The joint 58 of the drive pinion 54 is spline-connected to the front propeller shaft 31 (FIG. 1) so that a drive force from the power unit 16 (FIG. 1) can be transmitted to the differential case assembly 60 by means of the drive pinion 54.

FIG. 6 is an exploded cross-sectional view showing the limited-slip differential (differential case assembly) 50 with the ring gear 75 (FIG. 4) omitted for clarity. As previously explained with reference to FIG. 5 and as will become apparent from FIG. 6, the left output cam 81 is disposed in the end cap 74 with the spring washer 85 and the thrust washer 84 disposed therebetween. The right output cam 82 is disposed in the cup-shaped case body 73. The case body 73 and the end cap 74 are assembled together so that the input blocks 77, 78 arranged in a circumferential direction are gripped between the left and right output cams 81, 82. In an assembled state, the left and right output cams 81, 82 are urged rightward in FIG. 6 by the force of the spring washer so that the right output cam 82 is forced against the inside surface of the cup-shaped case body 73.

As thus for explained, the limited-slip differential according to the present invention comprises a differential case assembly including a differential case having a two-piece structure formed by a cup-shaped case body and an end cap attached to an open end of the cup-shaped case body. The limited-slip differential having such two-piece differential case has a small number of parts, is easy to assemble and can be manufactured efficiently at a low cost, as compared to the conventional limited-slip differential having a three-piece differential case.

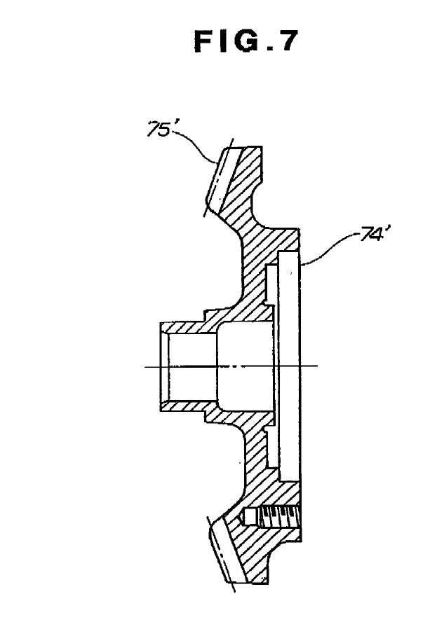

FIG. 7 shows a modified form of the end cap according to the present invention. The modified end cap 74′ has a ring gear 75′ formed integrally therewith. Integral formation of the end cap 74′ and the ring gear 75′ provides a further reduction of the number of parts used, leading to a further cost-reduction of the limited-slip differential.

Obviously, various minor changes and modifications are possible in the light of the above teaching. It is to be understood that within file scope of the appended claims the present invention may be practiced otherwise than as specifically described.

The present disclosure relates to the subject matter of Japanese Patent Application No. 2001-371915, filed Dec. 5, 2001, the disclosure of which is expressly incorporated herein by reference in its entirety.

What is claimed is:

1. A limited-slip differential incorporated in a final drive of a motor vehicle for limiting differential action between left and right driving wheels to thereby secure power transfer to each of the driving wheels, said limited-slip differential comprising:
a differential case having two-piece structure formed by a cup-shaped case body and an end cap attached to an open end of the cup-shaped case body.

2. A limited-slip differential according to claim 1, further comprising a ring gear formed integrally with the end cap.
